(19) United States
(12) Patent Application Publication
(10) Pub. No.: US 2012/0166259 A1
(43) Pub. Date: Jun. 28, 2012

(54) Adjusting Demand Parameters To Reduce Allocation Errors in Display Advertising

(76) Inventors: WenJing Ma, Sunnyvale, CA (US); Ramana Yerneni, Cupertino, CA (US); Erik Vee, San Mateo, CA (US); Sumanth Jagannath, Sunnyvale, CA (US); Jayavel Shanmugasundaram, Santa Clara, CA (US); Chandrashekar Nagarajan, Santa Clara, CA (US); Srinath Mandalapu, Santa Clara, CA (US)

(21) Appl. No.: 12/980,190

(22) Filed: Dec. 28, 2010

(51) Int. Cl. G06Q 30/00

(52) U.S. Cl. 705/14.4

(57) ABSTRACT

A system and method for adjusting demand parameters to produce an optimized allocation plan for delivering a plurality of impressions to a plurality of contracts for display advertising. The method commences upon receiving a first eligibility graph, the first eligibility graph comprising a plurality of impressions, a plurality of contracts and at least one first demand parameter. For reducing errors in sampling that affect the eligibility graph, demand parameters contained within the first eligibility graph are adjusted, resulting in an adjusted first eligibility graph. Once the adjusted first eligibility graph is available, a network solver is used for solving the adjusted first eligibility graph to produce an adjusted allocation plan, which adjusted allocation plan is used for displaying at least one of the plurality of impressions.

### FIELD OF THE INVENTION

The present invention relates generally to display advertising, more specifically to the optimization of an advertisement allocation plan for allocating advertisements to contracts in a network-based display advertising environment.

### BACKGROUND OF THE INVENTION

Since the widespread acceptance of the Internet, advertising as a source of revenue has proven to be both effective and lucrative. Advertising on the Internet provides the possibility of allowing advertisers to cost-effectively reach highly specific target audiences as opposed to traditional broadcast, and print media advertising media that reach only broadly definable target audiences (e.g. radio listeners in the greater Memphis area).

To facilitate advertisement placement, a website manager (e.g. a website operator, and/or their agents, advertising agents, ad server network providers, third-party ad delivery services, etc) may provide systems that allow the advertiser to book a number of impressions across websites that target the specified audience, where each impression corresponds to the display of an advertisement to an Internet user. For example, the system may enable an advertiser to book 1 million impressions that target “males, living in California”. These impressions may then be allocated across several websites that seek to attract “males living in California”.

The number of impressions available for booking may be related to the number of impressions that were available in the past. A website manager may use information from the past to forecast the number of impressions that may be available for future booking. The data collected may be arranged within various supply pools of impression inventory where each supply pool represents a number of impressions that target a specific audience. For example, a given pool may represent 1 million impressions that target males living in California. Or, another pool may represent 400,000 impressions that target “males living in San Francisco”.

However, as the number of websites available for advertising has increased, and as the number of targeting characteristics has increased, so too have the number of pools involved in the impression inventory. As earlier indicated, the number of impressions available for booking may be related to the number of impressions that were available in the past. However, in some cases the extent of the inventory in the pools (i.e. the number of forecasted impressions in a given pool) may overlap with the extent of other pools. For example, probably all of the pool containing an impression forecast for “males living in San Francisco” are also forecasted in the pool containing an impression forecast for “males living in California”.

Following the aforementioned example, it would be possible for a forecasting system to book a contract for delivery of 1 million impressions targeting “males living in California” and also book a different contract for delivery of 400,000 impressions targeting “males living in San Francisco”. As can be seen, the two contracts would require 1.4 million impressions in order for both contracts to be fully satisfied, even though there are only 1 million unique impressions forecasted to become available (since the 400,000 “males living in San Francisco” are a proper subset of “males living in California”).

The aforementioned example is but one error (resulting in over forecasting) that can occur when various inter-related pools of impression inventory are formed. Other errors, including other sources for errors (e.g. sampling errors) when forming pools of impression inventory, can result in under-forecasting. Errors resulting in under- or over-forecasting of supply and/or errors resulting from other sources introduce errors in subsequent processing. For example the allocated demand pertaining to a specific contract may be under- or over-estimated, and then various related demand parameters also under- or over-estimated. As another example, forecasting errors can be propagated when forming an allocation plan for matching forecasted inventory (i.e. impressions) to demand (i.e. contracts).

Some legacy attempts at detecting and correcting errors when forming pools of impression inventory have been tried, however such legacy attempts suffer from limitations. Further, legacy attempts at detecting and correcting errors when defining demand parameters have been tried, however such legacy attempts for adjusting demand parameters also suffer from limitations, which limitations have only become worse over time, especially since the number of targeting characteristics has increased over time. Accordingly, there exists a need for a adjusting demand parameters to reduce allocation errors in display advertising.

### SUMMARY OF THE INVENTION

A system and method for adjusting demand parameters (e.g. weightings, percentages) to produce an optimized allocation plan for delivering a plurality of impressions to a plurality of contracts for display advertising. The method commences upon receiving an eligibility graph, the eligibility graph comprising a plurality of impressions, a plurality of contracts and at least one first demand parameter. Rather than solve for an allocation plan using a large eligibility graph, the eligibility graph is reduced in size by using sampling techniques, to result in a smaller eligibility graph. This smaller eligibility graph, while representative of the original large eligibility graph can contain errors introduced as a consequence of the sampling techniques employed. For reducing errors in sampling that affect the eligibility graph, embodiments disclosed herein adjust various demand parameters contained within the smaller eligibility graph, resulting in an adjusted eligibility graph. Once the adjusted eligibility graph is available, a network solver is used for solving the adjusted eligibility graph to produce an adjusted allocation plan, which adjusted allocation plan is used for displaying at least one of the plurality of impressions.

### BRIEF DESCRIPTION OF THE DRAWINGS

The novel features of the invention are set forth in the appended claims. However, for purpose of explanation, several embodiments of the invention are set forth in the following figures.

FIG. 1A depicts an allocation of impressions to contracts in the form of an eligibility graph, according to one embodiment.

FIG. 1B depicts an allocation of impressions to contracts in the form of an eligibility graph, and showing cross-linking according to one embodiment.

FIG. 2 depicts an allocation of impressions to contracts in the form of a bipartite eligibility graph showing demand parameters, according to one embodiment.

FIG. 3 depicts an advertising server network environment including modules for adjusting demand parameters to reduce allocation errors in display advertising, according to one embodiment.

FIG. 4 shows an index with target predicates in the form of an inverted index, according to one embodiment.

FIG. 5 depicts mathematical techniques for calculating an adjusted demand parameter, according to several embodiments.

FIG. 6A depicts a system for using a bipartite eligibility graph to produce an allocation plan for delivering a plurality of impressions to a plurality of contracts for display advertising, according to one embodiment.

FIG. 6B depicts a system for adjusting demand parameters to produce an adjusted allocation plan for delivering a plurality of impressions to a plurality of contracts for display advertising, according to one embodiment.

FIG. 6C depicts a system for adjusting demand parameters using an eligibility graph comparator to produce an adjusted allocation plan for delivering a plurality of impressions to a plurality of contracts for display advertising, according to one embodiment.

FIG. 7 depicts a block diagram of a system to perform certain functions of an advertising server network, according to one embodiment.

FIG. 8 is a diagrammatic representation of a network including nodes for client computer systems, nodes for server computer systems and nodes for network infrastructure, according to some embodiments.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

### DEFINITIONS

Some of the terms used in this description are defined below (in alphabetical order) for easy reference. These terms are not rigidly restricted to these definitions. A term may be further defined by the term's use in other sections of this description.

“Ad” (e.g. ad, item and/or message) means a paid announcement, as of goods or services for sale, preferably on a network such as the internet. An ad may also be referred to as an item and/or a message.

“Ad call” means a message sent by a computer to an ad server for requesting an ad to be displayed.

“Ad click-through rate” (e.g. click-through rate) means a measurement of ad clicks per a period of time.

“Ad server” is a server that is configured for serving one or more ads to user devices. An ad server is preferably controlled by a publisher of a website and/or an advertiser of online ads. A server is defined below.

“Advertiser” (e.g. messenger and/or messaging customer, etc) means an entity that is in the business of marketing a product and/or a service to users. An advertiser may include, without limitation, a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a website.

“Application server” is a server that is configured for running one or more devices loaded on the application server. For example, an application server may run a device configured for deducing shadow profiles.

“Click” (e.g. ad click) means a selection of an ad impression by using a selection device such as, for example, a computer mouse or a touch-sensitive display.

“Client” means the client part of a client-server architecture. A client is typically a user device and/or an application that runs on a user device. A client typically relies on a server to perform some operations. For example, an email client is an application that enables a user to send and receive email via an email server. In this example, the computer running such an email client may also be referred to as a client.

“Conversion” (e.g. ad conversion) means a purchase of a product/service that happens as a result of a user responding to an ad and/or a coupon.

“Database” (e.g. database system, etc) means a collection of data organized in such a way that a computer program may quickly select desired pieces of the data. A database is an electronic filing system. In some instances, the term “database” is used as shorthand for a “database management system”. A database may be implemented as any type of data storage structure capable of providing for the retrieval and storage of a variety of data types. For instance, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” means hardware, software or a combination thereof. A device may sometimes be referred to as an apparatus. Examples of a device include, without limitation, a software application such as Microsoft Word™ or a database; or hardware such as a laptop computer, a server, a display; or a computer mouse and/or a hard disk.

“Impression” (e.g. ad impression) means a delivery of an ad to a user device for viewing by a user.

“Item” means an ad, which is defined above.

“Message” means an ad, which is defined above.

“Messaging” means advertising, which is defined above.

“Network” means a connection, between any two or more computers, that permits the transmission of data. A network may be any combination of networks including, without limitation, the internet, a local area network, a wide area network, a wireless network, and/or a cellular network.

“Publisher” means an entity that publishes, on a network, a web page having content and/or ads, etc.

“Server” means a software application that provides services to other computer programs (and their users) on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload.

“Software” means a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” means a device or multiple coupled devices. A device is defined above.

“User” (e.g. consumer, etc) means an operator of a user device. A user is typically a person who seeks to acquire a product and/or service. For example, a user may be a woman who is browsing Yahoo!™ Shopping for a new cell phone to replace her current cell phone. The term “user” may also refer to a user device, depending on the context.

“User device” (e.g. computer, user computer, client and/or server, etc) means a single computer or a network of interacting computers. A user device is a computer that a user may use to communicate with other devices over a network, such as the internet. A user device is a combination of a hardware system, a software operating system, and perhaps one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and/or a Sun Microsystems™ workstation having a UNIX operating system.

“Web browser” means a software program that may display text or graphics or both, from web pages on websites. Examples of a web browser include, without limitation, Mozilla Firefox™ and Microsoft Internet Explorer™.

“Web page” means documents written in a mark-up language including, without limitation, HTML (hypertext mark-up language), VRML (virtual reality modeling language), dynamic HTML, XML (extensible mark-up language), and/or other related computer languages. A web page may also refer to a collection of such documents reachable through one specific internet address and/or through one specific website. A web page may also refer to any document obtainable through a particular URL (uniform resource locator).

“Web portal” (e.g. public portal) means a website or service that offers a broad array of resources and services such as, for example, email, forums, search engines, and online shopping malls. The first web portals were online services, such as AOL, that provided access to the web. However, now, most of the traditional search engines (e.g. Yahoo!™) have transformed themselves into web portals to attract and keep a larger audience.

“Web server” is a server configured for serving at least one web page to a web browser. An example of a web server is a Yahoo!™ web server. A server is defined above.

“Website” means one or more web pages. A website preferably includes a plurality of web pages virtually connected by links or URL addresses to form a coherent group.

### Introduction to Allocation Problems and Solutions

In a display advertising setting, there are many ways or policies for allocating a supply (e.g. an impression) to demand (e.g. a contract for display advertising). In one representation, pools of supply are matched-up to contracts in a graph. And the matching-up of demand to supply is carried out according to a set of rules (see Table 1, below). Such a matching-up can be calculated, then used at a future time for serving the matched-up impressions to contracts. Many such rules can be described in a serving policy statement. Table 1 enumerates several possible serving policy statements together with selected corresponding effects.

TABLE 1
Possible serving policies

| Policy Statement | Effect in Expectation |
|---|---|
| Serve to oldest contract | May over-serve older contracts while |
| | under-serving newer contracts |
| Serve to contract soonest | May under-serve contracts until it is too |
| to expire | late to catch up |
| Pre-compute an allocation and | Actual impressions arriving in future may |
| implement that allocation | differ from the allocation plan |
| Pre-compute an allocation and | Stateful allocation may require vast |
| implement that allocation | computing resources |

As can be seen from Table 1, each of the listed policy statements suffer from at least one undesired effect. Nevertheless, the policies based on computation of an allocation plan can be used in optimization engines (see further details below), and are often preferred in high-performance advertising. In the context of computing an allocation plan, errors resulting in under forecasting or over forecasting of supply can introduce errors in computed allocation plans.

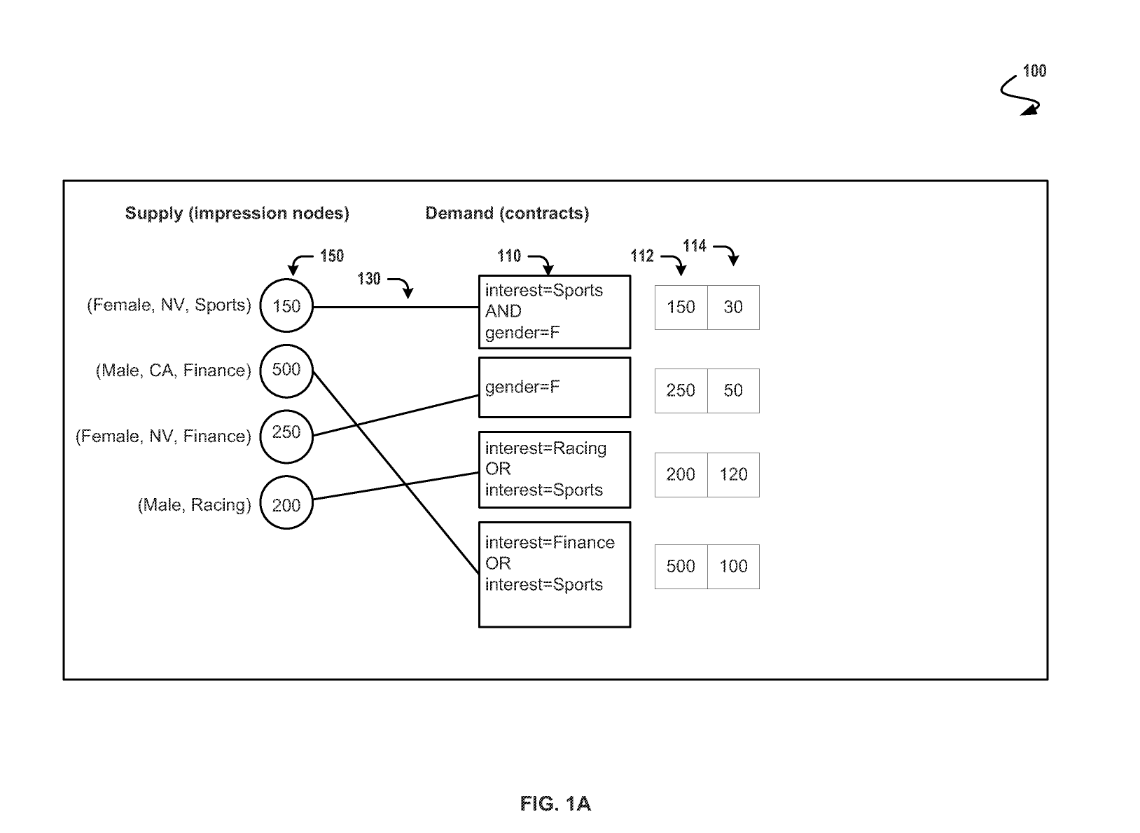

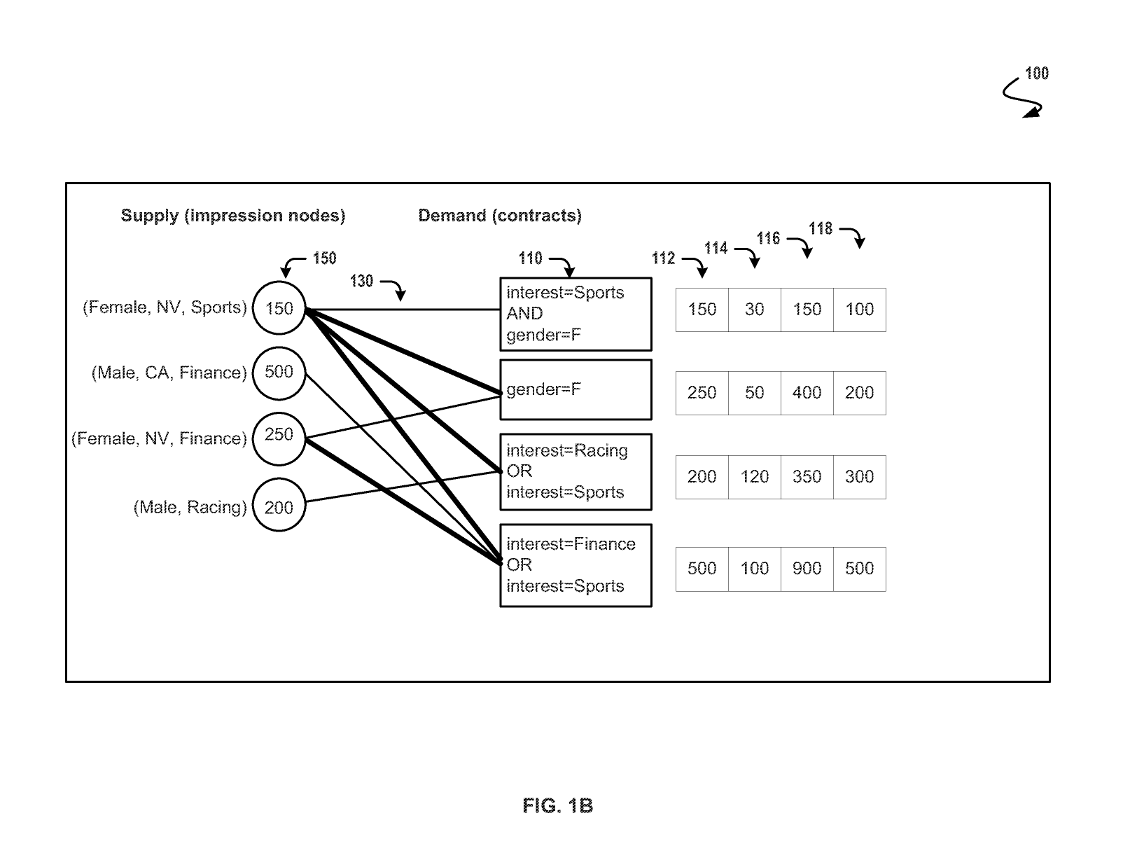

FIG. 1A depicts an allocation of impressions to contracts in the form of an eligibility graph (e.g. the eligibility graph 100).

The left-hand vertices (depicted as circles) consist of I (i.e. a supply of impressions); the right-hand vertices (depicted as rectangles) consist of J (i.e. demand from contracts). The edge-set, E, consists of edges (i, j) such that i is eligible for contract j. The set of user visits (i.e. supply) eligible for contract j is denoted by E(j). Likewise, the set of contracts eligible for i is denoted by E(i). Note that the eligibility graph shows characteristics (e.g. gender, interest, etc) of a user (e.g. Female, Sports) as well as the target predicates (e.g. gender=M).

Also shown are numeric quantities used in techniques for adjusting demand parameters to reduce allocation errors in display advertising. Specifically, the supply of impressions (depicted as circles) are annotated with a numeric magnitude of supply. For example, a value of 150 might represent 150 thousand impressions available in a certain time period. Also, on the right side of FIG. 1A, the left column of the tabularized data shows a first-pass eligibility magnitude 112. For example, the value 150 in the topmost cell of column for the first-pass eligibility magnitude 112 indicates that the contract for “interest=Sports AND Gender=F” is assigned a value of 150, that 150 corresponds to the number of impressions available from the supply node “(Female, NV, Sports)”. Yet, even though the number eligible impressions is 150, the contract for “interest=Sports AND Gender=F” may only demand say 30 (thousand) impressions within the time period. Several instances of a demand parameter 114 for each of the contracts are also shown. Continuing this example, if the number eligible impressions is 150, and the contract for “interest=Sports AND Gender=F” demands only say 30 (thousand) impressions within the time period, that leaves (in this example) 70 impressions remaining unallocated. This undesired situation as well as other errors than can be present in an eligibility graph (which error may also be present in an allocation plan) motivate the embodiments herein. A rigorous discussion of allocation problems and their solutions now follows.

### Allocation Problems: Problem Statement

In an exemplary allocation problem, a publisher may be associated with a set of booked contracts, and the publisher may posess information about future user visits. One possible allocation problem goal can be described as: Find an allocation of user visits to contracts such that every user visit is allocated to at most one contract, and each contract j is allocated to at least dⱼ impressions. Let xε{0,1}^{E} denote the allocation, set xᵢⱼ=1 to mean that the ad associated with contract j is shown for the impression i, and xᵢⱼ=0 otherwise.

The publisher may have some objective function,

H:{0,1}^{E}→R (Eq. 1)

over the set of feasible allocations. Such an objective function generally relates the goals of revenue, advertiser satisfaction, and user happiness, though other objective functions are reasonable and envisioned.

Thus, the allocation problem may be formally written as:

$$Maximize H ( x )$$

$$\begin{matrix}s . t . ∀ j , {\sum }_{i ∈ E ( j )}^{ } {x}_{ij} \geq {d}_{j} & subject to a demand constraint \\ ∀ i , {\sum }_{j ∈ E ( i )}^{ } {x}_{ij} \leq 1 & subject to a supply constraint \\ ∀ i , j , {x}_{ij} ∈ \{ 0 , 1 \} & subject to an integrality constraint\end{matrix}$$

### Allocation Problems: Solution Possibilities

Solutions to the allocation problem described above present many difficulties. An eligibility graph corresponding to a commercially reasonable problem size might include billions of user visits (e.g. impressions 150), and tens of thousands of contracts 110, resulting in trillions of edges 130 encoded into a graph of the form of eligibility graph 100.

FIG. 1B depicts an allocation of impressions to contracts in the form of an eligibility graph, and showing cross-linking. As shown, some of the contracts (e.g. those shown with thick edges) are eligible for further impressions—this effect arising from the existence of multiple supply nodes that at least potentially comprise eligible supply. For example, the contract “gender=F” might be eligible for the supply from supply node “(Female, NV, Sports)”, as well as from supply node “(Female, NV, Finance)”. Thus, another magnitude parameter, namely, the increased eligible magnitude 116 (e.g. as shown in the next column) might be calculated by summing all of the magnitudes of impressions from all of the eligible supply nodes. As shown, the increased eligible magnitude for contract “gender=F” becomes a magnitude of 400. However, it might be the case that some or all of the impression supply corresponding to (for example) “(Female, NV, Sports)” might be the same impression supply corresponding to (for example) “(Female, NV, Finance)”. In such a situation, the magnitudes from the supply nodes might be multiply counted. Using any of a variety of techniques, including sampling (discussed below), the magnitudes might be corrected to more fairly reflect eligibility for unique impressions (i.e. to reduce the effects of multiple counting).

### Using Sampling Techniques for Determining an Allocation Plan

One way to make the allocation problem more tractable is to reduce the size of the overall problem by sampling from the set of user visits. For example, a sampling might be comprised from a uniform sample of, for example, 10% of user visits. Having thus sampled, then scaling each of the demand nodes appropriately (in this example, dividing them by a factor of 10). Although a sampling may not be a perfect representation of the whole set sampled, the resulting problem is smaller by an order of magnitude and, thus, might be easier to solve (especially for a small eligibility graph). Accordingly, one approach is to employ sampling (resulting in an allocation problem that is smaller by an order of magnitude), and correct for sampling errors (i.e. sampling bias) in subsequent processing.

### Introduction to Flow Network Representation for Inventory Allocation Optimization in Display Advertising

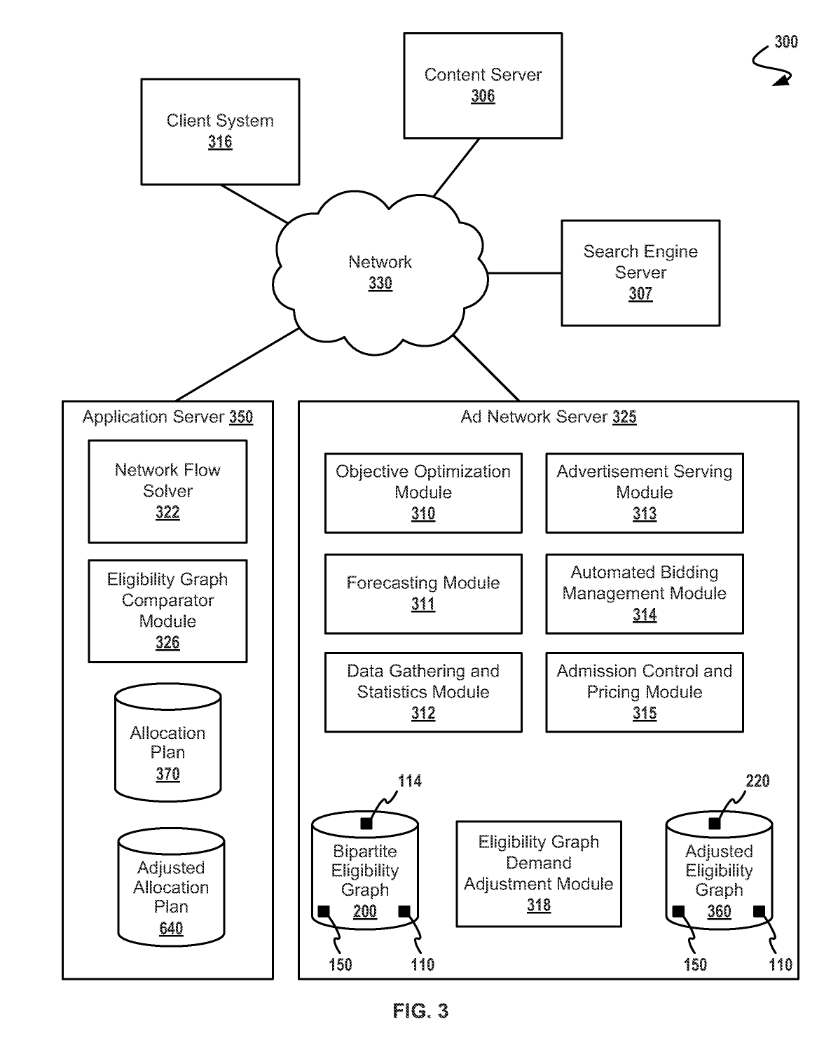

Referring again to FIG. 1B, the eligibility graph 100 also includes a plurality of the contracts 110 each including specific requests for impressions 150 that satisfy a demand profile during a time period. The graph includes a plurality of the edges 130 to connect the plurality of impressions 150 to the plurality of contracts 110 that match the demand profile characteristics (e.g. gender=F) of a particular contract. A demand profile and any aspects or characteristics comprising a demand profile can be stored as a data structure (see FIG. 3, below).

In this way, the inventory allocation problem can be represented as a network-flow optimization problem. The model is a bipartite network (e.g. eligibility graph 100) with supply nodes (e.g. impressions 150) and demand nodes (e.g. contracts 110). Each supply node is assumed to be composed of forecasted impressions, and thus a supply node represents forecasted impressions available for delivery to the demand nodes that are connected by an edge. A display advertising system can then represent an allocation plan in a form congruent to an eligibility graph 100. With the bipartite network formulated, an optimizer can then solve the bipartite network as a minimal-cost network flow problem.

The objective of such a network-flow optimizer is to satisfy the demands (or contracts 110) as much as possible, given the available supply (or forecasted impressions) through allocation of the forecasted impressions. The optimizer outputs an allocation plan, which includes a proposed allocation of impressions 150 to contracts 110 over the time period (which allocation plan may also specify the number of forecasted impressions flowing over each edge 130). In some embodiments, an allocation plan may specify a probability that a particular forecasted impression within the nodes will be delivered to a particular contract 110. It will be apparent to one of ordinary skill in the art that a raw number of allocated forecasted impression opportunities that may be output by the optimizer may be converted, by software known in the art, to a percentage value of the forecasted impression opportunities.

Such an allocation may include less than 100% allocation of a single impression node to some contracts, in particular where the allocation of the forecasted impression opportunities is apportioned across more than one contract 110. Furthermore, upon receipt of an impression that does not precisely match any stored in the forecasted impression opportunities nodes, the optimizer may search the forecasted impression opportunities for an impression that is similar to the received impression, and use the allocation plan of the similar forecasted impression opportunities for any future allocations of the received similar impression.

Thus, and as shown in FIG. 1B, an eligibility graph may also include a representation for a corrected eligibility parameter 118. Using any of a variety of techniques, including sampling, the magnitudes might be corrected to more fairly reflect eligibility for unique impressions (i.e. to reduce the effect of multiple counting), and such corrections can be reflected in a corrected eligibility parameter 118. Some specific techniques for applying such corrections to cross-linked eligibility graphs are further disclosed in commonly-owned U.S. patent application Ser. No. 12/257,241, filed Oct. 23, 2008 (now patent application publication 2010/0106556), which is hereby incorporated by reference.

As just mentioned, using any of a variety of techniques, the magnitudes might be corrected to reduce the effects of sampling, and/or the effects of multiple counting. Table 2 depicts several approaches to reduce the effects of sampling, and/or the effects of multiple counting.

TABLE 2
Possible Flows

| | | | Second |
|---|---|---|---|
| Flow | Input | First Operation | Operation |
| 1 | Eligibility Graph | Determine an Allocation Plan | — |
| 2 | Eligibility Graph | Adjust the Eligibility Graph | Determine an |
| | | | Allocation Plan |
| 3 | Eligibility Graph | Determine an Allocation Plan | Adjust the |
| | | | Allocation Plan |

As indicated in Table 2, each of the three flows includes using some form of an eligibility graph as input to a network solver. And, two of the three flows includes using at least one operation to perform adjustments. In flow #2, the adjustment is performed on the eligibility graph. In flow #3, the adjustment is performed in the allocation plan. Each of the flows are more fully described herein.

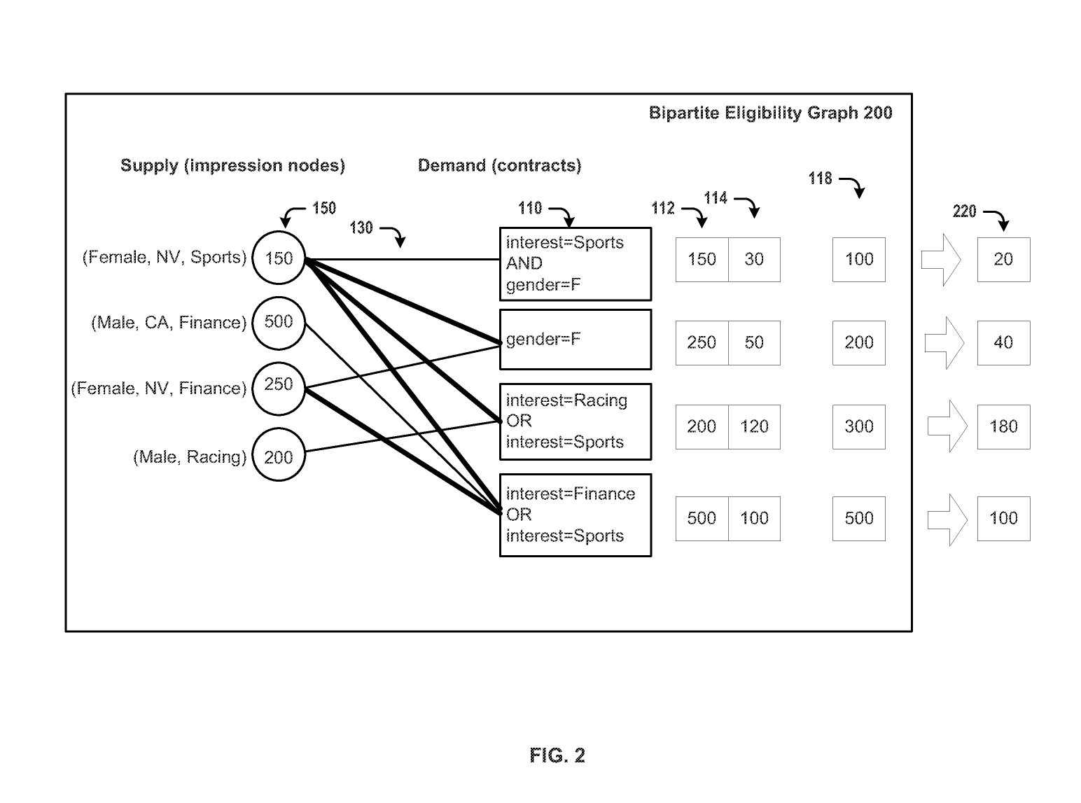

FIG. 2 depicts an allocation of impressions to contracts in the form of a bipartite eligibility graph (e.g. the bipartite eligibility graph 200) showing demand parameters (e.g. 114, 220), according to one embodiment. Such a representation can be stored into a database. For example, such a representation can be stored onto computer readable media as a bipartite eligibility graph containing a computer readable representation of one or more impressions 150, one or more contracts 110, edges 130, one or more demand parameters 114, and any other parameters (e.g. one or more instances of adjusted demand parameter 220) as may be conveniently recorded and store with the bipartite eligibility graph.

As earlier mentioned, such a representation (i.e. in the form of a computer readable database) can be regarded as an optimization problem, and given as an input to an optimizer or solver. There are multiple ways to solve a given optimization problem using an optimizer or solver. One way is to use a standard linear programming (LP) solver such as the Cplex (log.com) or Xpress-MP (dashoptimization.com) commercial software packages, or an open source software packages such as the COIN-OR Clp code (coin-or.org). The Xpress-MP is a suite of mathematical modeling and optimization tools used to solve linear, integer, quadratic, non-linear, and stochastic programming problems. An Xpress-Optimizer of the Xpress-MP suite features optimization algorithms which enable solving linear problems (LP), mixed integer problems (MIP), quadratic problems (QP), mixed integer quadratic problems (MIQP), quadratically constrained problems (QCQP), and convex general non-linear problems (NLP). An alternative way is to use a specialized minimum-cost network flow solver such as CS2 (igsystems.com/cs2/index.html). CS2 is an efficient implementation of a scaling push-relabel algorithm for minimum-cost, flow-transportation problems.

The CS2 network flow solvers are typically much faster than a standard LP solver on this class of problems. However, they often require a feasible, balanced model as input. A solution is feasible when the number of forecasted impressions is at least equal to, and satisfies, the number and type of demands for impressions by the contracts 110. Other solvers as may be known or developed in the art may also be suitable.

As discussed above, the output of an optimizer is an allocation plan that specifies the number (or percentage) of forecasted impressions flowing over each edge 130. An allocation plan can be interpreted as specifying the fraction (or percentage) of the forecasted impressions that should be used to satisfy the demand of a particular contract. In some embodiments, an allocation plan can be codified as instructions to a server in the form of “orders”, the order expressed using demand parameters such as: For impression node 1: 50% goes to Contract 1, 20% to Contract 2; for impression node 2: 30% goes to Contract 2, 15% to Contract 3; etc.

However, there remain still more techniques to arrive an allocation plan. In particular, a bipartite eligibility graph 200 can be adjusted to create an adjusted eligibility graph that contains adjusted demand parameters, which adjusted demand parameters are used by a network flow solver, such that a better allocation plan results. As used herein, an adjusted eligibility graph differs from a bipartite eligibility graph 200 in at least one aspect.

More particularly, the demand parameters 114 can be adjusted based on ratios calculated from an original (unadjusted) demand parameter, a corrected eligibility parameter 118 and the original, first-pass eligibility magnitude 112.

D_{Adjusted}=D*(Eligibility_{Corrected}/Eligibility) (Eq. 2)

where:
D_{Adjusted} is the desired adjusted demand parameter 220,
D is the original demand parameter 114
Eligibility_{Corrected} is the corrected eligibility parameter 118, and
Eligibility is first-pass eligibility magnitude 112.

As shown in FIG. 2, each instance of an adjusted demand parameter 220 (i.e. corresponding to a particular contract) can be individually calculated. Each individual instance of adjusted demand parameter 220 is calculated according to Eq. 2, as follows:

30*(100/150)=20

50*(200/250)=40

120*(300/200)=180

100*(500/500)=100

Any of the above or other techniques for calculating an adjusted demand parameter 220 may be employed using hardware and/or software-executing processors. Such an implementation using hardware and/or software-executing processors may be embodied within a networked advertising system.

### Overview of Networked Systems for Adjusting Demand Parameters in Online Advertising

FIG. 3 depicts an advertising server network environment including modules for adjusting demand parameters to reduce allocation errors in display advertising, in which some embodiments operate. In the context of internet advertising, placement of advertisements within an internet environment (e.g. environment 300 of FIG. 3) using an advertising server network has become common. By way of a simplified description, an internet advertiser may enter into a delivery contract such that whenever any internet user satisfying the terms of the delivery contract (e.g. contract 110) visits a web page (e.g. via a client system 316) the advertising system recognizes the visit as an opportunity for an impression 150 and renders the web page with an advertisement as per the delivery contract. In some cases, the web page may be associated with a particular property, and the user may have traversed to the particular property using a search engine server 307. Continuing, the advertisement is composited on a web page by one or more servers (e.g. an ad network server 325, a content server 306, etc) for delivery to a client system 316 over a network 330. Given this generalized delivery model, and using techniques disclosed herein, sophisticated online advertising might be practiced. More particularly, an advertising campaign might include highly-customized advertisements delivered to a user corresponding to highly-specific target predicates, which highly-specific target predicates may correspond to a delivery contract. Again referring to FIG. 3, an internet property (e.g. a publisher hosting the publisher's base content on a content server 306) might be able to measure the number of visitors that have any arbitrary characteristic, demographic, target predicates, or attribute, possibly using an ad network server 325 in conjunction with a data gathering and statistics module 312. Thus, an internet user might be ‘known’ in quite some detail as pertains to a wide range of target predicates or other attributes, and such target predicates or other attributes can be used in describing an impression 150.

In embodiments of the systems within environment 300, components of the ad network server can perform processing such that, given an advertisement opportunity (e.g. an impression 150), an advertisement serving module 313 determines which (if any) contract(s) match the advertisement opportunity. More particularly, an advertisement serving module 313 can use an allocation plan 370, or an adjusted allocation plan 640, either of which allocation plans can in turn, result from processing an eligibility graph, possibly using a network flow solver 322, and/or possibly using an eligibility graph comparator module 326. As shown, the application server 350 can host a plurality of modules and data structures, for example a network flow solver 322, an eligibility graph comparator module 326, and an allocation plan 370, and an adjusted allocation plan 640.

In some embodiments, the environment 300 might host a variety of modules to serve as management and control operations (e.g. an objective optimization module 310, a forecasting module 311, a data gathering and statistics module 312, an advertisement serving module 313, an automated bidding management module 314, an admission control and pricing module 315, etc) pertinent to serving advertisements to users, including serving ads based on an eligibility graph (e.g. a stored form of a bipartite eligibility graph 200, or an adjusted eligibility graph 360). In particular, the modules, network links, algorithms, assignment techniques, serving policies, and data structures embodied within the environment 300 might be specialized so as to perform a particular function or group of functions reliably while observing capacity and performance requirements. As shown, the bipartite eligibility graph 200 includes at least one demand parameter 114. The adjusted eligibility graph 360 includes at least one adjusted demand parameter 220.

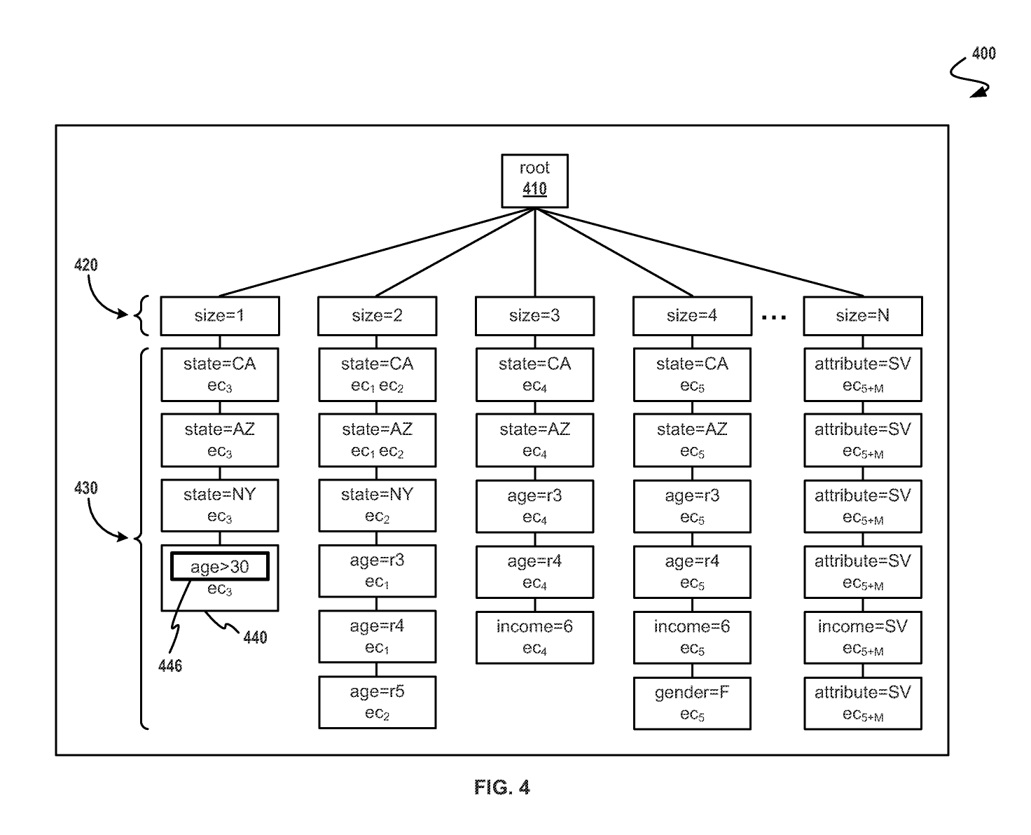

FIG. 4 shows an index with target predicates in the form of an inverted index 400. As an option, the inverted index may be implemented in the context of the architecture and functionality of the embodiments described herein. Of course, however, the inverted index with target predicates or any portion therefrom may be used in any desired environment. In the context of adjusting demand parameters to reduce allocation errors in display advertising, embodiments can use an inverted index 400 for determining if an impression is eligible for a contract, which eligibility is used to construct an eligibility graph. Some embodiments implement a service for performing impression-to-contract eligibility checks by using an inverted index in the form of inverted index 400. Many technique exist for constructing an inverted index. As shown, an index with target predicates in the form of an inverted index 400 comprises a tree structure stemming from an inverted index root 410 into the inverted index branches 420 (labeled as size=1, . . . size=3, . . . size=N) under which inverted index branches 420 are index predicate nodes 430. In the particular embodiment shown, the index predicate nodes 430 are labeled with a target predicate (e.g. state=CA, state=AZ, etc) and with corresponding labels indicating one or more particular contracts (e.g. ec₁, ec₂, ec₃, etc) that might be satisfied (e.g. matched, at least in part) with respect to the target predicate of that node. For example, for the sample node 440, contract ec₃ might be eligible (at least in part) to be delivered when the example target predicate 446 age>30 matches the particular user visit impression opportunity with the event predicate of the user visit impression opportunity (e.g. the user is of age>30). Of course, the foregoing structure is only an illustrative example, and other structures are reasonable and envisioned.

In more formal terms, one might say that a user visit impression iεI is eligible for contract jεJ if, and only if, it satisfies the target predicates of j. It can also sometimes be said that j is eligible for i.

Thus, it can be understood that, using an inverted index (or other contract matching technique), a particular user visit impression can be matched to any number of eligible contracts, or it can be determined that a particular user visit impression cannot be matched to any eligible contracts.

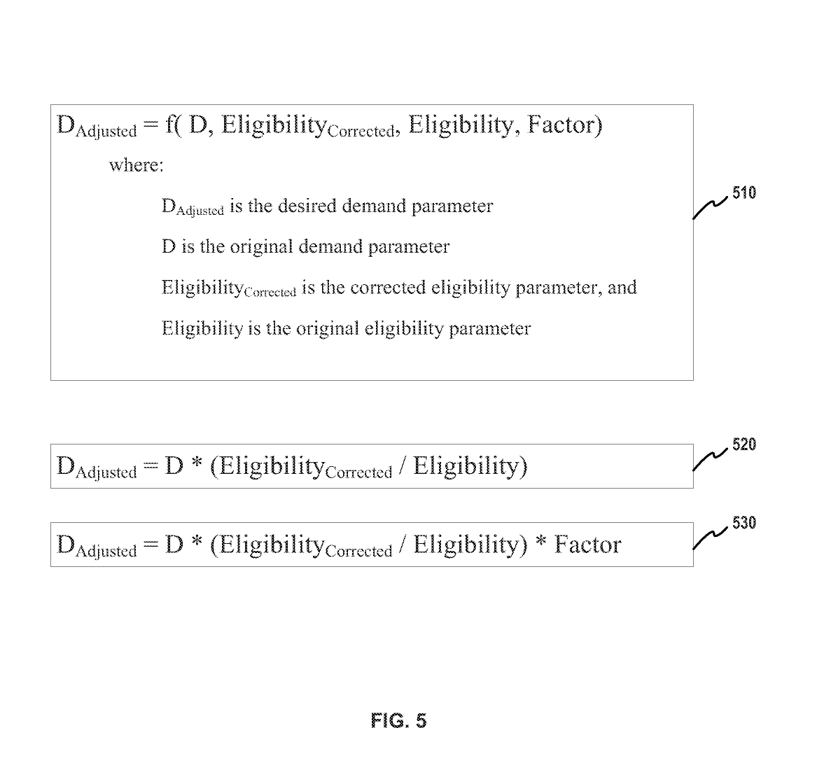

FIG. 5 depicts mathematical techniques for calculating an adjusted demand parameter, according to several embodiments. As shown, the example function 510 gives an adjusted demand parameter in terms of an arbitrary function. The function can be written in terms of the quantities D_{Adjusted}, D, Eligibility_{Corrected}, Eligibility, and a Factor).

where:
D_{Adjusted} is the desired demand parameter
D is the original demand parameter
Eligibility_{Corrected} is the corrected eligibility parameter 118, and
Eligibility is first-pass eligibility magnitude 112.

Additional equations are given. For example, the equation 520 gives D_{Adjusted} as related to the ratio of Eligibility_{rected}, and Eligibility. The equation 530 gives D_{Adjusted} as related to the ratio of Eligibility_{Corrected}, and Eligibility, that is further scaled by an adjustment factor.

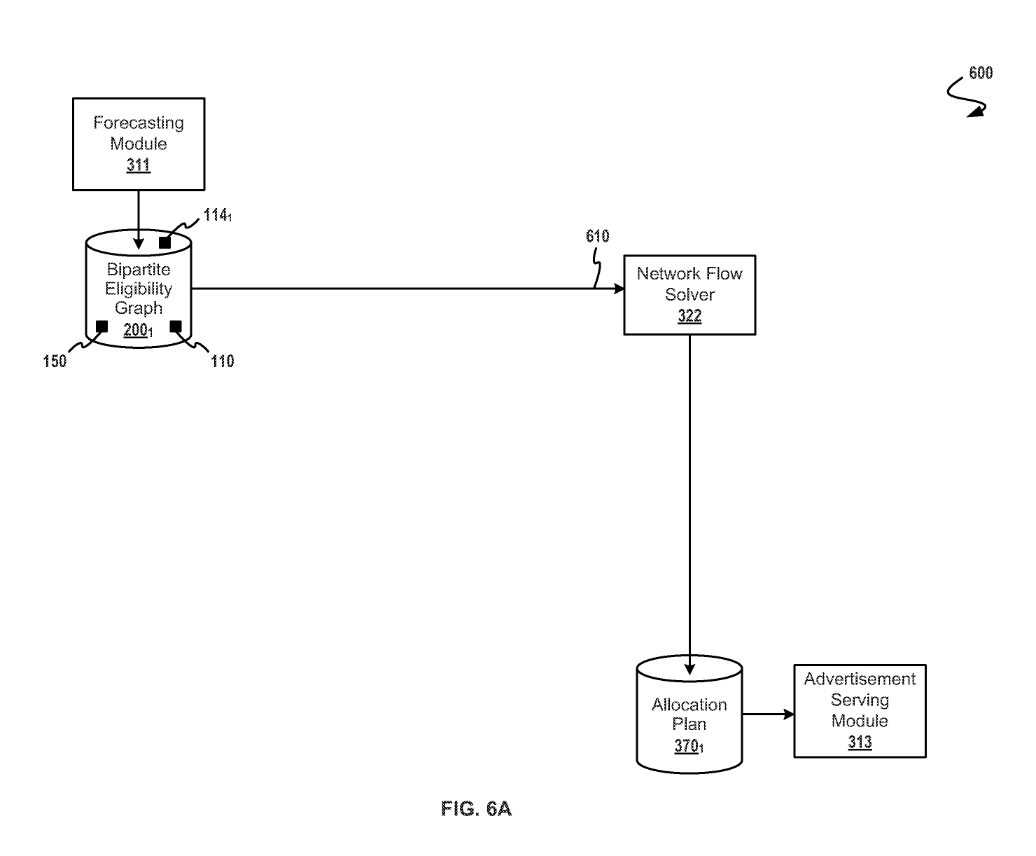

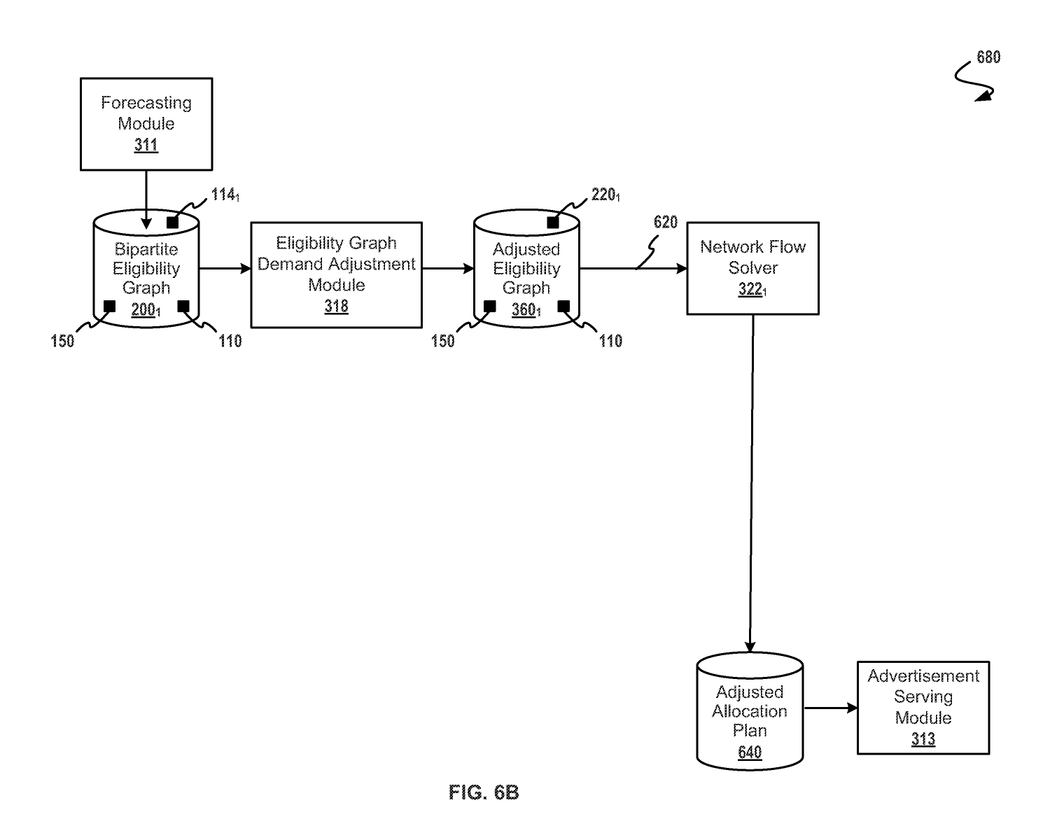

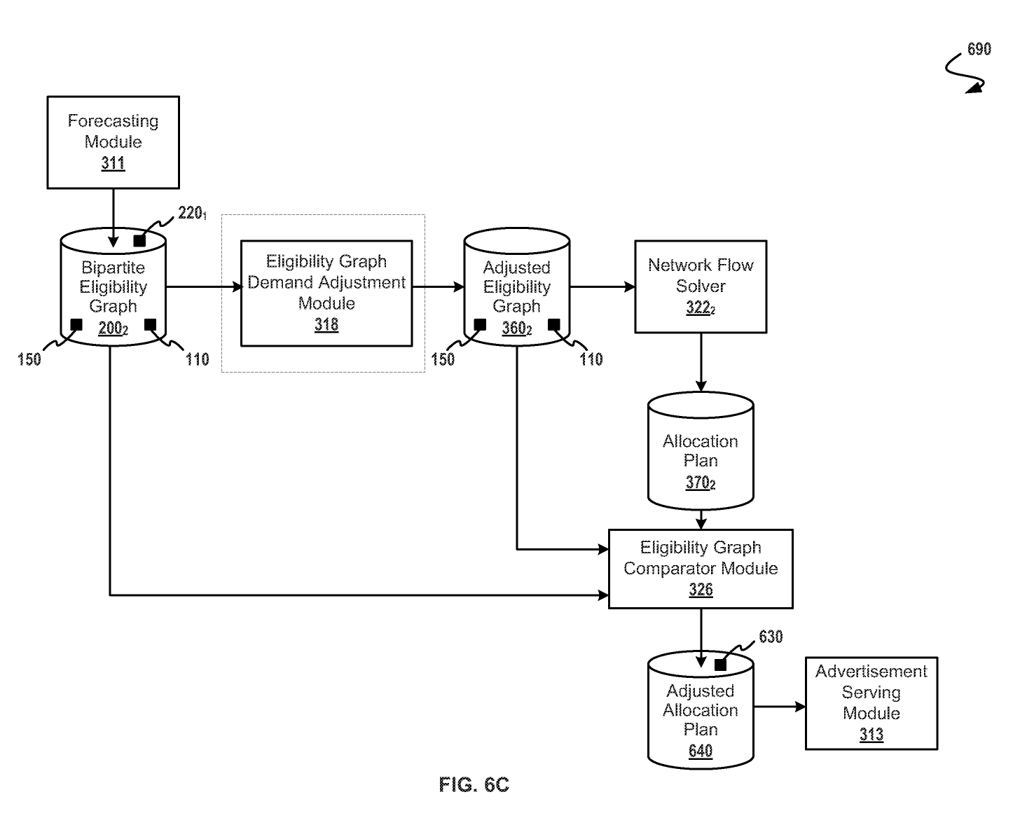

FIG. 6A depicts a system 600 for using a bipartite eligibility graph to produce an allocation plan for delivering a plurality of impressions to a plurality of contracts for display advertising. As shown, flow through the system commences when a first eligibility graph (e.g. bipartite eligibility graph 200₁) is received from a server (e.g. from a forecasting module 311). As previously described, the first eligibility graph (e.g. bipartite eligibility graph 200₁) includes a plurality of impression nodes, a plurality of contract nodes, and at least one first demand parameter. Processing continues as the first eligibility graph is then input (e.g. over path 610) to a network flow solver 322, for solving the first eligibility graph to produce an allocation plan 370₁ according to an optimization objective function (e.g. as described in Eq. 1). The resulting allocation plan 370₁ is then used by an advertisement serving module 313 for delivering impressions to contracts and displaying advertisements at a client system.

Yet further optimizations (including use of a range of optimization objective functions) are possible using one or more techniques as described herein. As merely one example, some embodiments perform operations for optimizing an advertisement plan for allocating advertisements to a contract in a network-based environment uses the technique of determining a shadow price. A shadow price generally reflects the contention for an advertisement placement relative to a plurality of advertisement contracts for a user that have similarly defined characteristics. In other embodiments, a shadow price may reflect the contention for an advertisement placement relative to a variety of factors including time interval, geographic location, demographic profile, the context of the advertisement placement, etc. For example, the contention for an advertisement placement during a live streaming of the Super Bowl may be higher than the contention for an advertisement placement for less popular sporting events. Other factors relative to the determination of the contention for an advertisement placement will be apparent to one of ordinary skill in the art. Otherwise stated, a willingness to pay (and contention between willing advertisers) may depend on a variety of factors including, but not limited to, a time interval, the context of a particular advertisement placement, a plurality of users that have similarly defined characteristics, and the type of advertising technique used in presenting the advertisement. In another embodiment, the willingness to pay may depend on the particular advertising model employed. Particular advertising models may be impression-based or conversion-based, depending upon a return on advertisement spend (“ROAS”) or cost-per-acquisition (“CPA”) performance model.

In some embodiments, an advertisement serving module 313 and an objective optimization module 310 may receive a sample of forecasting information from the forecasting module 311 then calculate a shadow price and/or other aspects of contention for the targeted impressions.

FIG. 6B depicts a system 680 for adjusting demand parameters to produce an adjusted allocation plan for delivering a plurality of impressions to a plurality of contracts for display advertising, according to one embodiment.

The system serves to reduce the adverse impact of the discrepancies in the reweighted matching supply and the original matching supply of the demand nodes. One technique (as earlier described as Flow #2) is to adjust the demand amount of each demand node based on the discrepancy between its matching supply amounts before and after the cross-linking and/or reweighting operations (also see FIG. 5). Adjustments are applied on a bipartite supply-demand graph before an allocation plan is computed. That is, a network flow solver is employed to solve the allocation problem on a bipartite supply-demand graph (e.g. adjusted eligibility graph 360₁) that reflects adjusted supply for each demand node and correspondingly adjusted demand amounts. Then, the just mentioned bipartite supply-demand graph is input (e.g. over path 620) to a network flow solver 322, for solving the bipartite supply-demand graph to produce an adjusted allocation plan 640. In this embodiment, as shown, the flow through the system commences when a first eligibility graph (e.g. bipartite eligibility graph 200₁) is received from a server (e.g. from a forecasting module 311). The first eligibility graph is adjusted (e.g. using an eligibility graph demand adjustment module 318) such that a first demand parameter contained within the first eligibility graph is adjusted to create an adjusted demand parameter 220₁, within an adjusted eligibility graph (e.g. adjusted eligibility graph 360₁). Then, following the path 620, a network flow solver 322₁, for solving the bipartite supply-demand graph (e.g. adjusted eligibility graph 360₁) resulting in an adjusted allocation plan 640. Comparing to the embodiment of FIG. 6A, the adjusted eligibility graph 360₁ is used as input to the network flow solver instead of using the bipartite eligibility graph 200₁ as an input to to the network flow solver. The resulting adjusted allocation plan 640 is then used by an advertisement serving module 313 for delivering impressions to contracts and displaying advertisements at a client system.

Again, returning to the example of FIG. 2 the adjustments as applied in system 680 are further detailed in the following Table 3.

TABLE 3
Detailed Example of Flow #2

| | | | | | Demand |
|---|---|---|---|---|---|
| | | Original | Corrected | Adjusted | Parameter (in |
| Supply | Demand | Eligibility | Eligibility | Demand | Allocation Plan) |
| 100 | 30 | 150 | 100 | 20 | 0.2 |
| 300 | 50 | 250 | 200 | 40 | 0.2 |
| 100 | 120 | 200 | 300 | 180 | 0.6 |
| 200 | 100 | 500 | 500 | 100 | 0.2 |

FIG. 6C depicts a system 690 for adjusting demand parameters using an eligibility graph comparator to produce an adjusted allocation plan for delivering a plurality of impressions to a plurality of contracts for display advertising, according to one embodiment.

The system serves to reduce the adverse impact of the discrepancies in the reweighted matching supply and the original matching supply of the demand nodes. The embodiment of FIG. 6C shows a technique for adjusting the demand amount of each demand node based on the discrepancy between its matching supply amounts before and after the cross-linking and/or reweighting operations (See FIG. 5). As discussed in the embodiment of FIG. 6B, adjustments can be applied on the bipartite supply-demand graph (e.g. a bipartite eligibility graph 200₁) to produce an adjusted eligibility graph 360₂ before allocation is computed using a network flow solver. Alternatively, and as depicted by omitting some or all of the operations contained within the dashed-line region, one technique for reducing the errors is to compute an allocation plan 370₂ using the original demand amounts (e.g. as embodied in bipartite eligibility graph 200) and the reweighted supply amounts (e.g. as embodied in adjusted eligibility graph 360₂). Computing the allocation plan 370₂ may include using an optimization objective function (e.g. as described in Eq. 1). As shown, processing continues as allocation plan 370₂ is adjusted by an eligibility graph comparator module 326 to produce an adjusted allocation plan 640. The eligibility graph comparator module 326 can make adjustments directly to the computed demand parameters in the allocation plan (e.g. any one or more instances of an adjusted plan demand parameter 630) based on the differences between the original matching supply and the reweighted matching supply for each demand node. The resulting adjusted allocation plan 640 (containing at least one adjusted plan demand parameter 630) is then used by an advertisement serving module 313 for delivering impressions to contracts and displaying advertisements at a client system.

The adjustments as applied in system 690 can be applied using the following equation.

D_{Adjusted}D*(Eligibility_{Corrected}/Eligibility) (Eq. 3)

where:
D_{Adjusted} is the desired adjusted plan demand parameter 630
D is the original allocation plan demand parameter
Eligibility_{Corrected} is the corrected eligibility parameter 118, and
Eligibility is first-pass eligibility magnitude 112.

Again, returning to the example of FIG. 2 the adjustments as applied in system 690 can be applied using the above equation, which adjustments are further detailed in Table 4.

TABLE 4
Detailed Example of Flow #3

| | | | Demand | | Adjusted |
|---|---|---|---|---|---|
| | | | Parameter | | Plan Demand |
| | | | (in | | Parameter |
| | | Original | Allocation | Corrected | (in Adjusted |
| Supply | Demand | Eligibility | Plan) | Eligibility | Allocation Plan) |
| 100 | 30 | 150 | 0.3 | 100 | 0.2 |
| 300 | 50 | 250 | 0.25 | 200 | 0.2 |
| 100 | 120 | 200 | 0.4 | 300 | 0.6 |
| 200 | 100 | 500 | 0.2 | 500 | 0.2 |

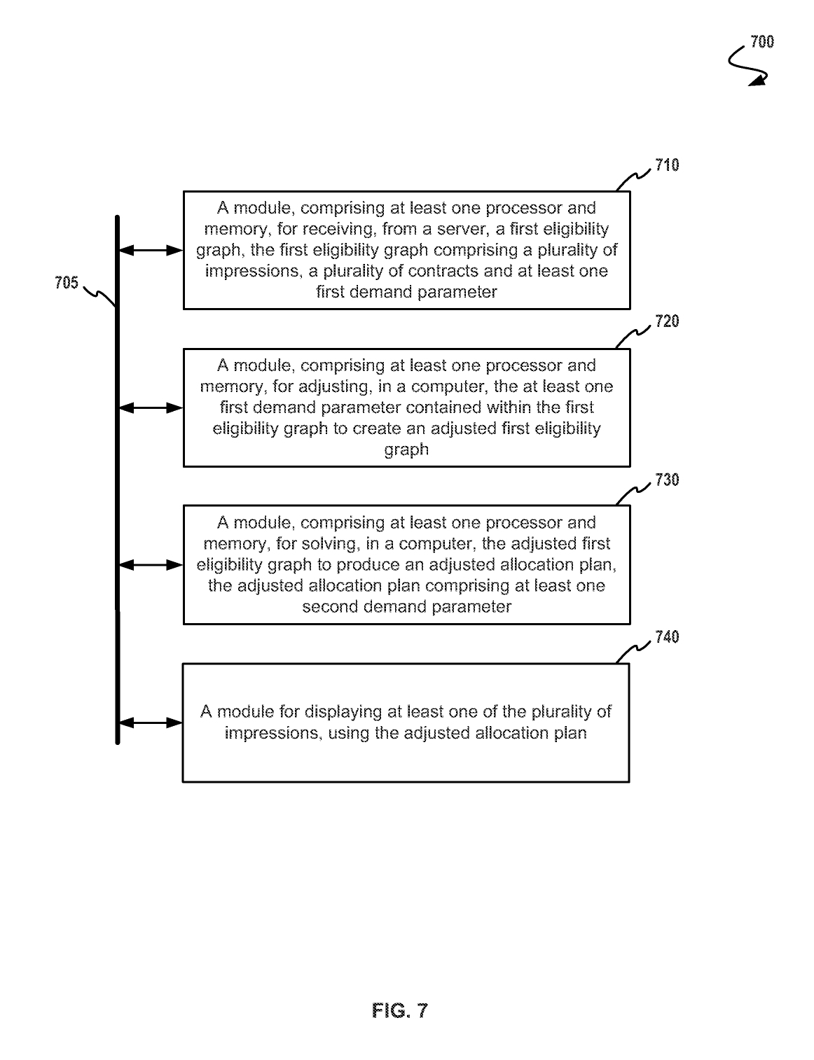

FIG. 7 depicts a block diagram of a system to perform certain functions of an advertising server network, according to one embodiment. As an option, the present system 700 may be implemented in the context of the architecture and functionality of the embodiments described herein. Of course, however, the system 700 or any operation therein may be carried out in any desired environment. As shown, system 700 comprises a plurality of modules, a module comprising at least one processor and a memory, each connected to a communication link 705, and any module can communicate with other modules over communication link 705. The modules of the system can, individually or in combination, perform method steps within system 700. Any method steps performed within system 700 may be performed in any order unless as may be specified in the claims. As shown, system 700 implements a method for display advertising, the system 700 comprising modules for: receiving, from a server, a first eligibility graph, the first eligibility graph comprising a plurality of impressions, a plurality of contracts and at least one first demand parameter (see module 710); adjusting, in a computer, the at least one first demand parameter contained within the first eligibility graph to create an adjusted first eligibility graph (see module 720); solving, in a computer, the adjusted first eligibility graph to produce an adjusted allocation plan, the adjusted allocation plan comprising at least one second demand parameter (see module 730); and displaying, on a display device, at least one of the plurality of impressions, using the adjusted allocation plan (see module 740).

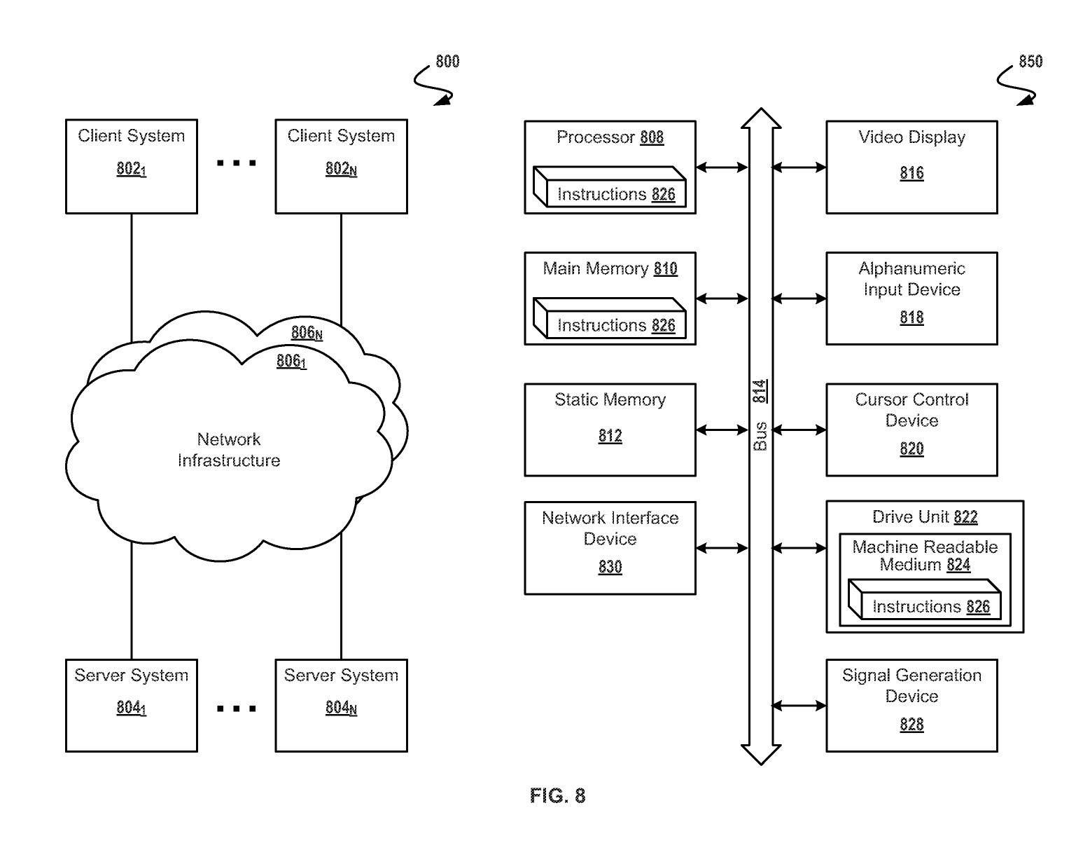

FIG. 8 is a diagrammatic representation of a network 800, including nodes for client computer systems 802₁ through 802_{N}, nodes for server computer systems 804₁ through 804_{N}, and network infrastructure nodes 806₁ through 806_{N}, according to some embodiments. The embodiment shown is purely exemplary, and might be implemented in the context of one or more of the figures herein.

Any node of the network 800 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 850 includes a processor 808 (e.g. a processor core, a microprocessor, a computing device, etc), a main memory 810 and a static memory 812, which communicate with each other via a bus 814. The machine 850 may further include a display unit 816 that may comprise a touch-screen, or a liquid crystal display (LCD), or a light emitting diode (LED) display, or a cathode ray tube (CRT). As shown, the computer system 850 also includes a human input/output (I/O) device 818 (e.g. a keyboard, an alphanumeric keypad, etc), a pointing device 820 (e.g. a mouse, a touch screen, etc), a drive unit 822 (e.g. a disk drive unit, a CD/DVD drive, a tangible computer readable removable media drive, an SSD storage device, etc), a signal generation device 828 (e.g. a speaker, an audio output, etc), and a network interface device 830 (e.g. an Ethernet interface, a wired network interface, a wireless network interface, a propagated signal interface, etc).

The drive unit 822 includes a machine-readable medium 824 on which is stored a set of instructions (i.e. software, firmware, middleware, etc) 826 embodying any one, or all, of the methodologies described above. The set of instructions 826 is also shown to reside, completely or at least partially, within the main memory 810 and/or within the processor 808. The set of instructions 826 may further be transmitted or received via the network interface device 830 over the network bus 814.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for adjusting demand parameters to produce an optimized allocation plan for delivering a plurality of impressions to a plurality of contracts for display advertising, comprising:
receiving, from a server, a first eligibility graph, the first eligibility graph comprising the plurality of impressions, the plurality of contracts and at least one first demand parameter;
adjusting, in a computer, the at least one first demand parameter contained within the first eligibility graph to create an adjusted first eligibility graph;
solving, in a computer, the adjusted first eligibility graph to produce an adjusted allocation plan, the adjusted allocation plan comprising at least one second demand parameter; and
displaying, on a display device, at least one of the plurality of impressions, using the adjusted allocation plan.

2. The method of claim 1, further comprising using the adjusted allocation plan for allocating an impression to one of a plurality of contracts for display advertising.

3. The method of claim 1, wherein the adjusting is performed using the formula:
D_{Adjusted}=D*(Eligibility Corrected/Eligibility).

4. The method of claim 1, wherein at least one instance within the plurality of contracts is includes requests for impressions that satisfy a demand profile during a time period.

5. The method of claim 1, wherein the first demand parameter is included in a demand profile.

6. The method of claim 1, wherein the adjusting includes calculating differences between two eligibility graphs.

7. The method of claim 1, wherein the solving includes using a linear programming solver.

8. A advertising server network for adjusting demand parameters to produce an optimized allocation plan for delivering a plurality of impressions to a plurality of contracts for display advertising, comprising:
a module, comprising at least one processor and memory, for receiving a first eligibility graph, the first eligibility graph comprising the plurality of impressions, the plurality of contracts and at least one first demand parameter;
a module, comprising at least one processor and memory, for adjusting the at least one first demand parameter contained within the first eligibility graph to create an adjusted first eligibility graph;
a module, comprising at least one processor and memory, for solving the adjusted first eligibility graph to produce an adjusted allocation plan, the adjusted allocation plan having at least one second demand parameter; and
a display device for displaying at least one of the plurality of impressions, using the adjusted allocation plan.

9. The advertising server network of claim 8, further comprising using the adjusted allocation plan for allocating an impression to one of a plurality of contracts for display advertising.

10. The advertising server network of claim 8, wherein the adjusting is performed using the formula:
D_{Adjusted}=D*(Eligibility_{Corrected}/Eligibility).

11. The advertising server network of claim 8, wherein at least one instance within the plurality of contracts is includes requests for impressions that satisfy a demand profile during a time period.

12. The advertising server network of claim 8, wherein the first demand parameter is included in a demand profile.

13. The advertising server network of claim 8, wherein the adjusting includes calculating differences between two eligibility graphs.

14. The advertising server network of claim 8, wherein the solving includes using a linear programming solver.

15. A computer readable medium comprising a set of instructions which, when executed by a computer, cause the computer to adjust demand parameters to produce an optimized allocation plan for delivering a plurality of impressions to a plurality of contracts for display advertising, comprising, the set of instructions for:
receiving, from a server, a first eligibility graph, the first eligibility graph comprising the plurality of impressions, the plurality of contracts and at least one first demand parameter;
adjusting, in a computer, the at least one first demand parameter contained within the first eligibility graph to create an adjusted first eligibility graph;
solving, in a computer, the adjusted first eligibility graph to produce an adjusted allocation plan, the adjusted allocation plan having at least one second demand parameter; and
displaying, on a display device, at least one of the plurality of impressions, using the adjusted allocation plan.

16. The computer readable medium of claim 15, further comprising using the adjusted allocation plan for allocating an impression to one of a plurality of contracts for display advertising.

17. The computer readable medium of claim 15, wherein the adjusting is performed using the formula:
D_{Adjusted}=D*(Eligibility_{Corrected}/Eligibility).

18. The computer readable medium of claim 15, wherein at least one instance within the plurality of contracts is includes requests for impressions that satisfy a demand profile during a time period.

19. The computer readable medium of claim 15, wherein the first demand parameter is included in a demand profile.

20. The computer readable medium of claim 15, wherein the solving includes using a linear programming solver.
